(19) United States
(12) Patent Application Publication
(10) Pub. No.: US 2004/0030051 A1
(43) Pub. Date: Feb. 12, 2004

(54) Polypropylene having low isotacticity and relatively high melting point

(76) Inventors: Yoshikuni Okumura, Frankfurt am Main (DE); Toshiaki Ishikawa, Oita (JP)

Correspondence Address: William R Reid, Basell USA Inc, Intellectual Property, 912 Appleton Road, Elkton, MD, 21921, US

(21) Appl. No.: 10/416,115

(22) PCT Filed: Oct. 25, 2001
(86) PCT No.: PCT/EP01/12424

(30) Foreign Application Priority Data
Nov. 13, 2000 (JP) 12/345588

(51) Int. Cl. C08L 23/00

(52) U.S. Cl. 525/240

(57) ABSTRACT

A propylene polymer having the following characteristics: (E) 50≦mmmm: 85%; (F) Tm≦50.ε^{0.012 (mmmm)}; (G) Esol≦5 wt %; and (H) 2,1-regioerrors≦0.05%; wherein mmmm represents the isotacity ba the pentad indication, Tm represents the melting point of the polymer, Esol represents the posrtion of the polymer soluble in boiling diethyl ether and 2,1 regioerrors represents the head-to-head insertions on the polymer chain.

The present invention relates to polypropylene having a low isotacticity and a relatively high melting point. The polymer can be used widely for various uses as a flexible material having a high strength. In polypropylene (PP), it is known that the difference of the isotacticity affects a number of features, such as the melting point and the crystallizing degree of the polymer. In order to improve the flexibility of the polypropylene the isotacticity (mmmm) of the polymer is usually reduced. When a low isotactic polymer having mmmm<85% is produced by using the Ziegler-Natta catalyst in the conventional type, however, volatile components having the low molecular weight and the like are simultaneously formed as by-products in the polymer to cause unavoidable bad influences upon the product. The use of a metallocene catalyst can solve the aforementioned problem since the polymer produced has a narrow molecular weight distribution. The isotactic PP produced with the conventional metallocene catalyst is known to have the tendency to have a lower melting point even if it has the same isotacticity (mmmM) in comparison with that produced with a Ziegler-Natta catalyst, because of the homogeneous distribution of derangement of the isotacticity and the existence of regioirregular defects (2,1-bond, 1,3-bond). On the other hand, syndiotactic PP, atactic PP, hemi-isotactic PP (Macromol. Chem., Macromol. Symp. 1991, 48/49 253) and stereoblock PP (Macromolecules 1998, 31, 6908) produced by using the conventional metallocene catalyst and having a isotacticity (mmmu) lower than 50% are used as flexible materials but a lot of applications require an isotacticity higher than 50%. Thus it is desirable to find a polypropylene polymer having a low isotacticity but a relatively high melting point.

The present invention provides a polypropylene that simultaneously satisfy the following relations:

(A) 50≦mmmm≦85%

(B) Tm≧50·e^{0.0124 (mmmm)}

(C) Esol≦5 wt %

(D) 2,1-regioerrors≦0.05%

wherein mmmm represents the isotacticity by the pentad indication, 2,1-regioerrors represents the percentage of the head-to-head insertions on the polymer chain, Tm represents the melting point of the polymer, and Esol represents the portion of the polymer soluble in boiling diethyl ether. Preferably, the 2,1-regioerrors are ≦0.03%, more preferably, the 2,1-regioerrors are ≦0.01%. The PP of the present invention will be explained in further detail.

The isotacticity of the PP of the present invention satisfies the equation (A). This means that the PP is an isotactic PP having a relatively low isotacticity. The PP of the present invention is characterized by further satisfying the relation (B). This means that the PP of the present invention has a higher melting point compared with the conventional PP even if both of the PPs have the same isotacticity. This phenomenon is explained from the structure of the polymer, that is, it means (1) that there are few or no regioirregular defects (2,1-regioerrors) which cause reduction of the melting point, other than the isotacticity defect, and (2) that the distribution of the isotacticity defect is not homogeneous in the polymer chain. Namely, in the conventional isotactic PP, the isotacticity defect was isolatedly observed as illustrated by the following formula (only mmrr and mrrm are observed by the ¹³C-NMR measurement).

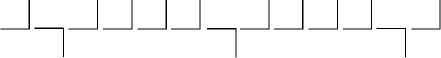

On the other hand, the PP of the present invention has the continuous isotacticity defects as illustrated by the following formula (rrrr and the like are observed by the ¹³C-NMR measurement). Accordingly, it can be considered that the PP has long parts of the isotactic chain, resulting in a high crystallization degree and a high melting point.

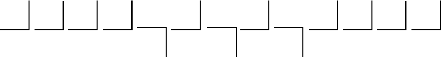

The PP of the present invention further satisfies the relation (C). This means that the PP hardly contains components having an extremely low isotacticity which are extracted with a boiling ether (such as atactic PP). A stereoblock PP comprises 30 wt % or more of the components that can be extracted with a boiling ether. The catalyst system which is used for preparing the polypropylene of the present invention is preferably a metallocene catalyst, more preferably a catalyst system composed of (1) a titanocene compound, and (2) a Lewis acid compound. Each catalyst component is explained below.

(1) Titanocene Compounds

The useful titanocene compound has a ligand bridged with different (substituted) cyclopentadienyl groups. More specifically, the titanocene compound is represented by the following general formula (1):

ZR″Z′Ti QₖAₗ (1)

wherein

(a) Z is a ligand which comprises a (substituted) cyclopentadienyl group, may contain a heteroatom, and has at least one substituent of the size stereoscopically equal to or more of methyl group at the β-position (the position adjacent to that connecting to the bridging part);

(b) Z′ is a ligand which comprises a (substituted) fluorenyl group and may contain a heteroatom;

(c) R″ is a bridging part;

(d) Q represents a straight or branched alkyl group, an aryl group, an alkenyl group, an alkylaryl group, an arylalkyl group, or a halogen atom;

(e) A is a counter anion;

(f) k is an integer of from 1 to 3;

(g) 1 is an integer of from 0 to 2;

(h) ZR″Z′ has the C₁ symmetry.

Preferably the titanocene compounds has formula (1a):

ZR″Z′Ti Qₖ (1a)

wherein

Z is an unsubstituted or substituted cyclopentadienyl group, optionally condensed to one or more unsubstituted or substituted, saturated, unsaturated or aromatic rings, containing from 4 to 6 carbon atoms, optionally containing one or more heteroatoms belonging to groups 13-16 of the Periodic Table of the Elements; Z′ is a cylopentadienyl group condensed with two unsubstituted or substituted, saturated, unsaturated or aromatic rings, containing from 4 to 6 carbon atoms, optionally containing one or more heteroatoms belonging to groups 13-16 of the Periodic Table of the Elements;

R″ is a divalent radical selected from the group consisting of: linear or branched, saturated or unsaturated C₁-C₂₀ alkylidene, C₃-C₂₀ cycloalkylidene, C₆-C₂₀ arylidene, C₇-C₂₀ alkylarylidene or C₇-C₂₀ arylalkyldene radicals, optionally containing one or more Si, Ge, O, S, P, B or N atoms;

Q is selected from the group consisting of, halogen atoms or a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms;

k is 2 and ZR″Z′ has the C₁ symmetry.

(a) Z is preferably selected from substituted cyclopentadienyl groups such as 3-methylcyclopentadienyl group, 2,4-dimethylcyclopentadienyl group, 3-ethylcyclopentadienyl group, 3-1-propylcyclopentadienyl group, 2-methyl-4-1-propylcyclopentadienyl group, 3-phenylcyclopentadienyl group, 3-(trimethylsilyl)cyclopentadienyl group, 3-t-butylcyclopentadienyl group, and 2-methylft-butylcyclopentadienyl group; substituted indenyl groups such as 3-methylindenyl group, 3-t-butylindenyl group, 2,4-dimethylindenyl group, and 2-methyl-4-phenylindenyl group; and the like. As the substituted cyclopentadienyl group containing a heteroatom, 5-methyl-cyclopenteno[b]thiophene, 2,5-dimethyl-1-phenyl-cyclopenteno[b]pyrrole and the like which are described in J. Am. Chem. Soc., 1998, 1,010786 may also be selected.

Other examples of Z can be: cyclopentadienyl, mono-, di-, tri- and tetra-methyl cyclopentadienyl; 4-tertbutyl-cyclopentadienyl; 4-adamantyl-cyclopentadienyl; indenyl; mono-, di-, tri- and tetra-methyl indenyl; 4,5,6,7-tetrahydroindenyl; 5,10-dihydroindeno[1,2-b]indol-10-yl; N-methyl- or N-phenyl-5,10-dihydroindeno [1,2-b]indol-10-yl; 5,6-dihydroindeno[2,1-b]indol-6-yl; N-methyl-or N-phenyl-5,6-dihydroindeno[2,1-b]indol-6-yl; azapentalene4-yl; thiapentalene-4-yl; azapentalene-6-yl; thiapentalene-6-yl; mono-, di- and tri-methyl-azapentalene-4-yl

(b) Z′ is preferably selected from substituted fluorenyl groups such as fluorenyl group, 2,7-dimethylfluorenyl group, 2,7-diphenylfluorenyl group, and 2,7-di-t-butylfluorenyl group; and the like. As the substituted cyclopentadienyl group containing a heteroatom, cyclopenteno[1,2-b:4,3-b′]dithiophene and the like may also be selected.

(c) R″ is preferably selected from the following bridge structures:

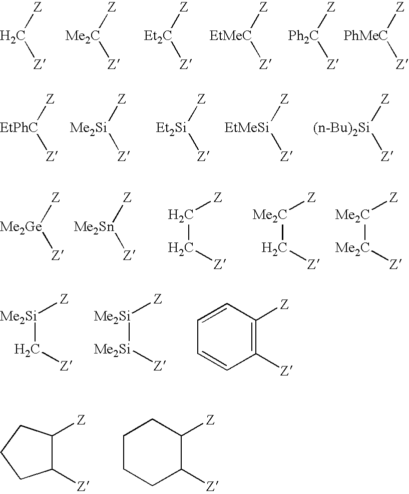

preferably R″ is Si(CH₃)₂, SiPh₂, CH₂, (CH₂)₂, (CH₂)₃ or C(CH₃)₂.

(d) Q is preferably selected from methyl group, benzyl group, and halogen atoms more preferably Q is methyl or chlorine;

(e) A is a counter anion, preferably a non-coordinate anion or a very weakly coordinated anion with titanocene cation. A varies in size according to the coordination structure of the counter titanocene cation.

(g) k represents an integer of from 1 to 3; preferably k is 2.

(g) 1 is an integer of from 0 to 2. When 1=0, the compound of the aforementioned formula (1) is a neutral titanocene compound, which is used as a precursor of the catalyst. When 1=1 to 2, formula (1) is a substance which represents an ion pair of a titanocene cation and a non-coordinate anion. The substance is obtained by the reaction between a precursor of the catalyst having 1=0 and (B) a Lewis acid compound; preferably 1 is 0.

(h) ZR″Z′ has the C, symmetrical structure. This symmetry is a condition necessary for obtaining the isotactic polymer which is the requirement of the present invention. In the general formula (1), specific examples where Q=Cl, k=2, and 1=0 are shown as follows:

Me₂C(3-MeCp)(Flu)TiCl₂, MeC(2,4-Me₂ Cp)(Flu)TiCl₂,

Me₂C(3-MeCp)(2,7-Me₂Flu)TiCl₂, Me₂C(3-MeCp)(2,7-t-Bu₂Flu)TiCl₂,

Me₂C(2,4-Me₂ Cp)(2,7-t-Bu₂Flu)TiCl₂,

Me₂C(3-t-BuCp)(Flu)TiCl₂, Me₂C(2-Me-4-t-BuCp)(Flu)TiCl₂,

Me₂C(3-t-BuCp)(2,7-Me₂Flu)TiCl₂, Me₂C(3-t-BuCp)(2,7-t-Bu₂Flu)Ti(Cl₂,

Me₂C(2-Me4-t-BuCp)(2,7-t-Bu₂Flu)TiCl₂,

Ph₂C(3-MeCp)(Flu)TiCl₂, Ph₂C(3-MeCp)(2,7-Me₂Fiu)TiCl₂,

Ph₂C(3-MeCp)(2,7-t-Bu₂Flu)TiCl₂,

Ph₂C(3-t-BuCp)(Flu)TiCl₂, Ph₂C(3-t-BuCp)(2,7-Me₂Flu)TiCl₂,

Ph2C(3-t-BuCp)(2,7-t-Bu₂Flu)TiCl₂,

Me₂C(3-MeInd)(Flu)TiCl₂, Me₂C(3-t-Bulnd)(Flu)TiCl₂,

Me₂C(2,4-Me₂Iud)(Flu)TiCl₂,

Me₂C(3-t-BuInd)(2,7-t-Bu₂Flu)TiC₂, Me2Si(3-MeInid)(lu)TiCl₂,

Me₂Si(3-t-Bulnd)(Flu)TiCl₂, Me₂Si(3-t-BuIud)(2,7-t-Bu2Flu)TiC2,

Ph₂C(3-MeInd)(Flu)TiCl₂, Ph₂C(3-t-BuInd)(F?lu)TiCl₂,

Ph₂C(2,4-Me₂Ind)(Flu)TiCl₂,

Ph₂C(3-t-Bulnd)(2,7-t-Bu₂Plu)TiCl₂.

(2) Lewis Acid Compound

A Lewis acid compound is reacted with the precursor of the catalyst where 10 in the general formula (1) and constitutes a part of the catalyst components. The Lewis acid compound is largely divided into the following two types.

(2-1) Organoaltmninoxy Compound

The first Lewis acid compound is an organoaluminoxy compound represented by the following general formula (2):

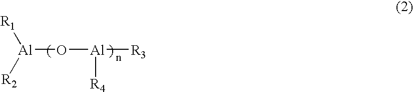

In formula (2), R¹, R² and R³ may be the same or different from each other, and are independently a hydrogen atom or a hydrocarbon group having from 1 to 10 of carbon atoms, preferably a methyl group, or i-butyl group. Plural R⁴s may be the same or different from each other, and are independently a hydrocarbon group having from 1 to 10 of carbon atoms, preferably a methyl group, or i-butyl group n is an integer of from 1 to 100, preferably from 3 to 100. The organoaluminoxy compound is used as a mixture thereof.

This kind of compounds can be produced by the known methods. For example, a method for adding a trialkylaluminum to a suspension of a salt having crystal water (copper sulfate hydrate, aluminum sulfate hydrate, and the like) in a hydrocarbon solvent, or a method for applying solid, liquid or gaseous water to a trialkylaluminum can be enumerated. Where n is two or more and R⁴s are the same, one kind of trialkylaluminum is used. Where n is two or more and R⁴s are different, two or more kinds of trialkylaluminum, or one or more kinds of trialkylaluminum and one or more kinds of dialkylaluminum halide may be used. Specifically, the material is selected from trialkylaluminum such as trimethylaluminum, triethylaluminum, tri(n-propyl)alurninum, tri(i-propyl)aluminum, tri(n-butyl)aluminum, tri(i-butyl)aluminum, tri(s-butyl)aluminum, tri(t-butyl)aluminum, tri(2,4-dimethylbutyl)aluminum, di(n-pentyl)(n-butyl)aluminum, di(n-hexyl)(n-butyl)aluminum, and dicyclohexyl(n-butyl)aluminum;

dialkylaluminum halide such as dimethylaluminum chloride, and di(i-butyl)aluminum chloride; dialkylaluminum alkoxide such as dimethylaluminum methoxide and the like. Among them, the preferred is trialkylaluminum, especially trimethylaluminum, and tri(i-butyl)aluminum. (2-2) Boron compound. Another group consists of other Lewis acid compounds which react with the metallocene compound to form an ionic complex. Among them, the preferred are boron compounds. Specifically, the preferred are boron compounds which have pentafluorophenyl group, p-methyltetrafluorophenyl group, or p-trimethylsilyltetrafluorophenyl group. Specific examples include tris(pentafluorophenyl)boron, tetra(pentafluorophenyl)borate tri(n-butyl)ammonium, tetra(pentafluorophenyl)borate dirnethylanilinium, tetra(pentafluorophenyl)borate pyridinium, tetra(pentafluorophenyl)borate ferrocenium, tetra(pentafluorophenyl)borate triphenylcarbenium and the like. To the aforementioned catalyst system, an organoaluminum compound can be added at need. The preferred organoaluminum is selected from trialkylaluminum such as trimethylaluminum, triethylaluminum, tri(n-propyl)aluminum, tri(i-propyl)aluminum, tri(n-butyl)aluminum, tri(i-butyl)aluminum, tri(s-butyl)aluminum, tri(t-butyl)aluminum, tri(n-pentyl)aluminum, tri(n-hexyl)aluminum, and tri(n-octyl)alumnnum; dialkylaluminum halide such as dimethylaluminum chloride, diethylaluminum chloride, and di(i-butyl)aluminum chloride; dialkylaluminum alkoxide such as dimethylaluminum methoxide, and diethylaluminum ethoxide; dialkylaluminum aryloxide such as diethylaluminum phenoxide; aluminoxane and the like. Among them, the preferred is trialkylaluminum, especially trimethylaluminum, triethylaluminum, tri(i-butyl)aluminum, and tri(n-octyl)aluminum.

The aforementioned catalyst system can be used in industry in a better condition by supporting the catalyst system on the following fine particle support. The fine particle support used has the mean particle size of usually from 10 to 300 μM, preferably from 20 to 200 μm. The support is not especially limited so long as it is in the state of fine particles and in a solid state in a medium for polymerization, which is selected from organic and inorganic substances. The preferred inorganic substances are inorganic oxides, inorganic chlorides, inorganic carbonates, inorganic sulfates, and inorganic hydroxides, and the preferred organic substances are organic polymers. The examples of the inorganic support include oxides such as silica and alumina; chlorides such as magnesium chloride; carbonates such as magnesium carbonate and calcium carbonate; sulfates such as magnesium sulfate and calcium sulfate; hydroxides such as magnesium hydroxide and calcium hydroxide and the like. The examples of the organic support include fine particles of an organic polymer such as polyethylene, polypropylene, and polystyrene. The preferred are inorganic oxides, especially silica, alumina, and their complex oxide. Among them, the particularly preferred are porous fine particle supports which bring about less adhesion of the polymer to the inside of a reactor and a higher bulk density of the resulting polymer. The porous fine particle support preferably has the specific surface area in the range of from 10 to 1,000 m²/g, more preferably from 100 to 800 m²/g, especially from 200 to 600 m²/g. The pore volume is preferably in the range of from 0.3 to 3 ml/g, especially from 1.0 to 2.0 mL/g. The amount of water adsorbed and that of hydroxyl group on the surface varies according to the treatment conditions. The water content is preferably 5 wt % or less, and the amount of hydroxyl group on the surface is preferably 1 or more groups/nm² of the surface area. The water content and the amount of hydroxyl group on the surface can be controlled by adjusting the burning temperature and treating with an organoaluminum compound, an organic boron compound, or another compound. In the polymerization, the titanocene compound can be allowed to contact with the other catalyst components at any time selected. The examples include a method in which a titanocene compound is previously allowed to contact with a Lewis acid compound (previous contact), while an organoaluminum and propylene are fed into a reactor, and the catalyst obtained by the previous contact is added to the reactor to initiate the polymerization. The concentrations of the catalyst components are not especially limited, and the concentration of the titanocene compound is preferably from 10⁻³ to 10⁻¹⁰ mol/L. As for the concentration of the organoaluminoxy compound, the molar ratio of the aluminum atom in the organoaluninoxy compound to the titanocene compound is preferably in the range of from 10 to 10,000, particularly from 100 to 5,000. As for the boron compound, the molar ratio of the boron compound to the titanocene compound is preferably in the range of from 0.1 to 100, particularly from 0.2 to 100. As for the organoaluminum, the molar ratio of the aluminum atom in the organoaluminum compound to the titanocene compound is preferably in the range of from 10 to 100,000, particularly from 100 to 10,000. A further object of the present invention is a process for the polymerization of one or more alpha olefins of formula CH₂═CHA wherein A is hydrogen or a Cl-C₁₋₀ alkyl radical, comprising the step of contacting one or more alpha olefins in the presence of a catalyst system obtainable by contacting a metallocene compound of formula (1) or (1a) as described above and a Lewis acid as described above.

Examples of alpha olefins are: ethylene, 1-butene, 1-hexene and 1-octene 4-methyl-1-pentene, preferably ethylene and propylene. Preparation of the polyolefin of the present invention can be carried out by any method known in the art such as solution polymerization, slurry polymerization, vapor-phase polymerization, and bulk polymerization. The polymerization conditions are not especially limited, and the polymerization temperature is preferably from −100° C. to 100° C. The catalyst system used can be extremely improved in its polymerization activity by supplying a slightly amount of hydrogen gas to the polymerization system in the polymerization regardless of the polymerization method. The concentration of hydrogen gas required for the effect to improve the activity is not especially limited, and the sufficient ratio of hydrogen to the monomer is from 1 to 10,000 mol ppm, preferably from 1 to 1,000 mol ppm. The hydrogen gas in the polymerization system can also be used as a molecular weight modifier. For this purpose, the concentration of hydrogen gas in the polymerization system can freely be set according to the desired molecular weight.

The melting point of the polymer can be measured by the DSC measurement through the following procedures. In the measurement, a 100 μm film ωproduced by the press molding is used. The press molding is carried out by melting the polymer at 230° C. for 5 minutes, maintaining the polymer at 230° C. under 5 MPa for 5 minutes, and cooling at 30° C. for 5 minutes. The resulting sample 100 μm in thickness is melted under the nitrogen atmosphere at 230° C. for 5 minutes, and then scanned with cooling at 20° C./minute. Then, the sample is maintained at 25° C. for 5 minutes, and the heat of fusion is measured by scanning with heating at 20° C./minute. The fusion curve is obtained by the measurement of the heat of fusion, and the temperature at the top of the endothermic peak in the fusion curve is given as the melting point. An indication of the isotacticity of polymers, mmmm %, is obtained by assigning the peaks of signals derived from methyl groups in the ¹³C-NMR spectrum in the range of from 19 ppm to 23.5 ppm according to the method described in Macromolecules, 8, 687 (1975), and calculating the pentad fraction from the integrated absorption of each peak. For the measurement of ¹³C-NMR, a 400 Mz nuclear magnetic resonance spectrum measurement apparatus is used. As the solvent in which the sample is dissolved, a mixed solvent of heavy benzene and 1,3,5-trichlorobenzene (at a volume ratio of 1:3) is used. For the measurement, 0.3 g of polypropylene to be measured is dissolved in 3 mL of the solvent at 120° C. and used. Measurement mode: proton decoupling; pulse width: 8.0 μs (40.40 pulse); pulse repeating period: 3.0 s; accumulation number: 20,000; internal standard: hexamethyldisiloxane; additive: Ciba-Geigy, Irganox (rg) 1010 made by Ciba-Geigy. The content of the soluble materials in boiling diethyl ether (Esol) is calculated by extracting 5 g of a polymer fluff in 300 mL of diethyl ether for 24 hours with a Soxhlet extractor under the nitrogen atmosphere, and subtracting from the polymer the remaining insoluble portions which are not extracted. The titanocene catalyst can be used for the polymerization of, other than propylene, ethylene; other α-olefins such as, for example, 1-butene, 1-pentene, 1-hexene, 1-heptene, 1-octene, 3-methyl-1-butene, 4-methyl-1-pentene, and styrene; cyclopentene, cyclohexene and the like. These olefins may solely be polymerized, and two or more kinds of them may be copolymerized.

The examples of the present invention are explained below. The present invention is not limited to these examples.

### EXAMPLES

In the examples, the polymers were analyzed by using the following apparatuses.

¹³c NMR: Nippon Denshi, EX-400

DSC: Perkin Elmer, DSC7 GPC: Waters, 150° C.; Showa Denko, ShodexHG-1 & TH-806M

### Example 1

(1) Synthesis of Ph₂C(3-t-BuCp)(Flu)TiCl₂ (T-1)

(1-1) Diphenyl(3-t-butyl-1-cyclopentadienyl)(9-fluorenyl)methane

Into a′500 mL three-neck flask, 5.8 g (35 mmol) of fluorene and 150 mL of diethyl ether were fed. A 1.6 M solution of n-butylithium in hexane (22 mL) was added at room temperature, and the mixture was stirred at room temperature for 2 hours. A solution of 2-t-butyl-6,6-diphenylflilvene (10 g, 35 mmol) in n-hexane (30 mL) was added, and the resulting solution was refluxed for 10 hours. Then, the reaction mixture was added with a saturated solution of ammonium chloride, the organic layer was separated, and the solvent was evaporated to obtain the desired compound. Yield 11.4 g, 72%.

(1-2) Diphenylmethylene(3-t-butyl-1-cyclopentadienyl)(9-fluorenyl)titanium Dichloride (Ph₂C(3-t-BuCp)(Flu)TiCl₂)

Diphenyl(3-t-butyl-1-cyclopentadienyl)(2,7-di-t-butyl-9-fluorenyl)methane (2.0 g, 4.4 mmol) was dissolved in 50 mL of diethyl ether, 5.5 mL of a 1.6 M solution of n-butyllithium in hexane was added dropwise, and the mixture was stirred at room temperature for 2 hours. The solvent was evaporated, and 100 mL of toluene was added. The resulting mixture was cooled to −78° C., added with 1.6 g (4.4 mmol) of titanium trichloride/TBF complex, gradually warmed to room temperature, and stirred for 12 hours. The mixture was added with 1.2 g (4.4 mmol) of lead chloride: PbCl₂, and further stirred at room temperature for 5 hours. The resulting suspension was filtered through a G-4 filter, and the residue was washed with 100 mL of toluene. The extract was concentrated to isolate the desired titanium compound: Ph₂C(3-t-BuCp)(Flu)TiCl₂.

(2) Propylene Polymerization

Into a stainless steel-made autoclave having the inner volume of 1.5 L which was sufficiently substituted with nitrogen, 4.5 mL of a 0.5 M solution of tri(i-butyl)aluminum (TIBA) in toluene and 8 mol of liquid propylene were fed, and the mixture was maintained at 50° C. On the other hand, a 0.5 M solution of methylaluminoxane (made by Tosoh Akzo) in toluene (Al/Zr=1,000) was added to a solution of Ph₂C(3-t-BuCp)(Flu)TiC₂ in toluene (5 μmol) to react at 30° C. for 5 minutes. The reaction mixture was introduced to the autoclave to initiate the polymerization. The polymerization was carried out at 30° C. for 30 minutes.

As a result, 5 g of isotactic polypropylene was obtained as a white powder. The activity for the titanocene compound was 2 kg-PP/mmol-Ti h. The molecular weight, melting point, and isotacticity distribution of the resulting polymer were measured as follows: Mw=161,100; Mw/Mn=2.36; Tₘ=141° C.; mmmm=79.65%; rmmr=7.83%; rmmr=1.31%; mmrr=6.14%; nmrrm+rmmr=1.22%; rmrm=0.38%; rrrr=0.28%; mrrr=0.33%; mrrm=2.86%. The extract in boiling diethyl ether was measured to be 0.5 wt %; no 2,1 insertions was observed. The results are summarized in table 1.

### Comparative example 1

The polymerization was carried out under the same conditions as those in Example 1, except that a zirconocene compound Ph₂C(3-t-BuCp)(lu)ZrCl₂ (Z-1) was used in place of the titanocene compound.

Activity=13 kg-PP/mmol-Zr h; Tₘ=125° C.; mmmm=80%.

As a result, it is revealed that a use of the zirconocene compound of Comparative example 1 as the catalyst component gives a polymer which does not satisfy the relation (B) and has a relatively low melting point to the isotacticity. The results are summarized in table 1.

### Example 2

(1) Synthesis of Ph₂C(3-t-BuCp)(2,7-t-Bu2Flu)TiCl₂ (T-2)

(1-1) Diphenyl(3-t-butyl-1-cyclopentadienyl)(2,7-di-t-butyl-9-fluorenyl)methane

Into a 500 mL three-neck flask, 11.4 g (41 mmol) of 2,7-di-t-butylfluorene and 150 mL of diethyl ether were fed. A 1.6 M solution of n-butyllithium in n-hexane (26 mL) was added at room temperature, and the mixture was stirred at room temperature for 2 hours. A solution of 2-t-butyl-6,6-diphenylfulvene (11.7 g, 41 mmol) in n-hexane (30 mL) was added, and the resulting solution was refluxed for 10 hours. Then, the reaction mixture was added with a saturated solution of ammonium chloride, the organic layer was separated, and the solvent was evaporated to obtain the desired compound. Yield 18 g, 78%.

(1-2) Diphenylmethylene(3-t-butyl-1-cyclopentadienyl)(2,7-di-t-butyl-9-fluorenyl)titanium dichloride (Ph₂C(3-t-BuCp)(2,7-t-Bu₂Flu)TiCl₂)

Diphenyl(3-t-butyl-1-cyclopentadienyl)(2,7-di-t-butyl-9-fluorenyl)methane (5.8 g, 10.2 mmol) was dissolved in 50 mL of diethyl ether, 13 mL of a 1.6 M solution of n-butyllithium in n-hexane was added dropwise, and the mixture was stirred at room temperature for 2 hours. The solvent was evaporated, and 100 mL of toluene was added. The resulting mixture was cooled to −78° C., added with 3.7 g (10.2 mmol) of titanium trichloride/THF complex, gradually warmed to room temperature, and stirred for 12 hours. The mixture was added with 2.8 g (10.2 mmol) of lead chloride PbCl₂, and further stirred at room temperature for 5 hours. The resulting suspension was filtered through a G-4 filter, and the residue was washed with 100 mL of toluene. The extract was concentrated to isolate the desired titanium compound Ph₂C(3-t-BuCp)(2,7-t-Bu₂Flu)TiCl₂.

(2) Propylene Polymerization

Into a stainless steel-made autoclave having the inner volume of 1.5 L which was sufficiently substituted with nitrogen, 4.5 mL of a 0.5 M solution of tri(i-butyl)aluminum (TIBA) in toluene and 8 mol of liquid propylene were fed, and the mixture was maintained at 50° C. On the other hand, a 0.5 M solution of methylaluminoxane (made by Tosoh Akzo) in toluene (Al/Zr=1,000) was added to a solution of Ph₂C(3-t-BuCp)(2,7-t-Bu₂Flu)TiCl₂ in toluene (5 pmol) to react at 30° C. for 5 minutes. The reaction mixture was introduced to the autoclave to initiate the polymerization. The polymerization was carried out at 50° C. for 30 minutes.

As a result, 18 g of isotactic polypropylene was obtained as a white powder. The activity for the titanocene compound was 7 kg-PP/mmol-Ti h. The molecular weight, melting point, and isotacticity of the resulting polymer were measured as follows: Mw=80,600; Mw/Mn=2.12; Tₘ=127° C.; mmmm=73.03%; mmmr=9.93%; rmmr=1.03%; mmrr=8.19%; mrmm+rmmr=1.69%; rmrm=0.56%; rrrr=0.61%; mrrr=0.51%; mrrm=4.45%. No redioirregular defect was observed by the ¹³C-NMR measurement. The extract in boiling diethyl ether was measured to be 1.5 wt %; no 2,1 insertions was observed. The results are summarized in table 1.

### Example 3

The polymerization was carried out under the same conditions as those in Example 2, except that hydrogen was introduced to the polymerization system at the hydrogen/propylene concentration ratio of 36 mol ppm.

Activity=58 kg-PP/mmol-Ti h; Mw=60,100; Mw/Mn=2.75; Tₘ=128° C.; mmmm=74.36%; mmmr=9.69%; mmr=1.18%; mmrr=8.42%; mrmm+rmmr=1.03%; mnrm=0.52%; rrrr=0.28%; mrTr=0.42%; mrrmn=4.10%. No 2,1 insertions was observed; the extract in boiling diethyl ether was measured to be 0.8 wt %. The results are summarized in table 1.

### Example 4

The polymerization was carried out under the same conditions as those in Example 2, except that hydrogen was introduced to the polymerization system at the hydrogen/propylene concentration ratio of 145 mol ppm.

Activity=73 kg-PP/mmol-Ti h; Mw=43,300; Mw/Mn=2.91; Tₘ=128° C.; mmmm=72.78%; mmmr=9.96%; rmmr=1.37%; mmrr=8.60%; mrmm+rmmr=1.18%; rmrm=0.71%; rrrr=0.43%; mrrr=0.57%; mrrnm=4.40%. No 2,1 insertions was observed; the extract in boiling diethyl ether was measured to be 1.2 wt %. The results are summarized in table 1.

### Example 5

Into a stainless steel-made autoclave having the inner volume of 1.5 L which was sufficiently substituted with nitrogen, 4.5 mL of a 0.5 M solution of tri(i-butyl)aluminum (TIBA) in toluene and 8 mol of liquid propylene were fed, and the mixture was maintained at 30° C. On the other hand, a 0.5 M solution of TIBA in toluene (Al/Ti=500) and a 2.0 mM solution of [ph₃C][(C₆F₅)₄₃] (TPFP13) in toluene (B/Ti=1.5) were added to a solution of Ph₂C(3-t-BuCp) (2,7-t-Bu₂Flu)TiCl₂ in toluene (5.0 pmol) to react at 30° C. for 5 minutes. The reaction mixture was introduced to the autoclave to initiate the polymerization. The polymerization was carried out at 30° C. for 30 minutes.

As a result, 7 g of isotactic polypropylene was obtained as a white powder. The activity for the titanocene compound was 3 kg-PP/mmol-Ti h. The molecular weight, melting point, and isotacticity of the resulting polymer were measured as follows: Mw=124,700; Mw/Mn=2.48; Tₘ=131° C.; mmmm=76.79%; mmmr=8.67%; rmmr=0.99%; mmrr=7.54%; mrmm+rmrnr=0.99%; rmnn=0.56%; rrrr=0.38%; mrrr=0.57%; mrmn=3.61%. No 2,1 insertions was observed; the extract in boiling diethyl ether was measured to be 1.0 wt %. The results are summarized in table 1.

### Comparative Example 2

The polymerization was carried out under the same conditions as those in Example 4, except that a zirconocene compound: Ph₂C(3-t-BuCp)(2,7-t-Bu₂Flu)ZrCl₂ (Z-2) was used in place of the titanocene compound.

Activity=41 kg-PP/mmol-Zr h; Mw=112,700; Mw/Mk=2.11; Tₘ=141° C.; mmmm=93.93%; mmmr=2.43%; mmrr=2.47%; mrrm=1.18%. 2,1 insertions of 0.36 mol % was observed by the ¹³C-NMR measurement.

As a result, it is revealed that, when the zirconocene compound of Comparative example 2 is used as the catalyst component, the resulting polymer does not satisfy the relations (A) and (B) and a polymer having a low isotacticity and a relatively high melting point cannot be produced. The results are summarized in table 1.

According to the present invention, polypropylene having a low isotacticity and a relatively high melting point can be produced at a high activity. The polymer can be used widely for various uses as a flexible material having the strength.

TABLE 1

| | | Tm | mmmm | rrrr | 2, 1 | E sol |
|---|---|---|---|---|---|---|
| Ex | Metallocene | ° C. | % | % | mol % | Wt/ |
| 1 | T-1 | 141 | 80 | 0.28 | 0 | 0.5 |
| 1* | Z-1 | 125 | 80 | 0 | | |
| 2 | T-2 | 127 | 73 | 0.61 | 0 | 1.5 |
| 3 | T-2 | 128 | 74 | 0.28 | 0 | 0.8 |
| 4 | T-2 | 128 | 73 | 0.43 | 0 | 1.2 |
| 5 | T-2 | 131 | 77 | 0.38 | 0 | 1.0 |
| 2* | Z-2 | 141 | 94 | 0 | 0.36 | |

*Comparative

1. A propylene polymer having the following characteristics:
(A) 50≦mmmm≦85%;
B) Tm≦50·e^{01.124(mmmm)};
(c) Esol≦5 wt %; and
(d) 2,1-regioerrors 50.05%;
wherein mmmm represents the isotacticity by the pentad indication, tm represents the melting point of the polymer, Esol represents the portion of the polymer soluble in boiling diethyl ether and 2,1-regioerrors represents the head-to-head insertions on the polymer chain:

2. The propylene polymer according to claim 1 wherein 2,1-regioerrors <0.01%.

3. A process for the polymerization of one or more alpha olefins of formula CH₂═CHA wherein A is hydrogen or a C₁-C₁₀ alkyl radical, comprising the step of contacting one or more alpha olefins in the presence of a catalyst system obtainable by contacting:
A) a titanocene compound of formula (1)
ZR″Z′TiQₖAₗ (1)
wherein
(a) Z is a ligand which comprises a (substituted) cyclopentadienyl group, may contain a heteroatom, and has at least one substituent of the size stereoscopically equal to or more of methyl group at the O-position (the position adjacent to that connecting to the bridging part);
(b) Z′ is a ligand which comprises a (substituted) fluorenyl group and may contain a heteroatom;
(c) R″ is a bridging part;
(d) Q represents a straight or branched alkyl group, an aryl group, an alkenyl group, an alkylaryl group, an arylalkyl group, or a halogen atom;
(e) A is a counter anion;
(f) k is an integer of from 1 to 3;
(g) 1 is an integer of from 0 to 2;
(h) ZR″Z′ has the C₁ symmetry; and
B) a Lecid.

4. The process according to claim 3 wherein the titanocene compound has formula (I a):
ZR″Z′TiQₖ (1a)
wherein
Z is an unsubstituted or substituted cyclopentadienyl group, optionally condensed to one or more unsubstituted or substituted, saturated, unsaturated or aromatic rings, containing from 4 to 6 carbon atoms, optionally containing one or more heteroatoms belonging to groups 13-16 of the Periodic Table of the Elements; Z′ is a cylopentadienyl group condensed with two unsubstituted or substituted, saturated, unsaturated or aromatic rings, containing from 4 to 6 carbon atoms, optionally containing one or more heteroatoms belonging to groups 13-16 of the Periodic Table of the Elements;
R″ is a divalent radical selected from the group consisting of: linear or branched, saturated or unsaturated C₁-C₂₀ alkylidene, C₃-C₂₀ cycloalkylidene, C₆-C₂₀ arylidene, C₇-C₂₀ alkylarylidene or. C₇-C₂₀ arylalkyldene radicals, optionally containing one or more Si, Ge, O, S, P, B or N atoms;
Q is selected from the group consisting of, halogen atoms or a linear or branched, saturated or unsaturated C₁-C₂₀ alkyl, C₃-C₂₀ cycloalkyl, C₆-C₂₀ aryl, C₇-C₂₀ alylar*l or C₇-C₂₀ arylalkyl group, optionally containing one or more Si or Ge atoms; and k is 2; and ZR″Z′ has the C, symmetry.

5. A titanocene compound of formula (1a):
ZR″Z′Ti Qₖ (1a)
wherein
Z is an unsubstituted or substituted cyclopentadienyl group, optionally condensed to one or more unsubstituted or substituted, saturated, unsaturated or aromatic rings, containing from 4 to 6 carbon atoms, optionally containing one or more heteroatoms belonging to groups 13-16 of the Periodic Table of the Elements; Z′ is a cylopentadienyl group condensed with two unsubstituted or substituted, saturated, unsaturated or aromatic rings, containing from 4 to 6 carbon atoms, optionally containing one or more heteroatoms belonging to groups 13-16 of the Periodic Table of the Elements;
R″ is a divalent radical selected from the group consisting of linear or branched, saturated or unsaturated C₁-C₂₀ alkylidene, C₃-C₂₀ cycloalkylidene, C₆-C₂₀ arylidene, C₇-C₂₀ alkylarylidene or C₇-C₂₀ arylalkyldene radicals, optionally containing one or more Si, Ge, O, S, P, B or N atoms;
Q is selected from the group consisting of, halogen atoms or a linear or branched, saturated or unsaturated C₁-C₂₀ alkyl, C₃-C₂₀ cycloalkyl, C₆-C₂₀ aryl, C₇-C₂₀ ayIary1 or C₇-C₂₀ arylalkyl group, optionally containing one or more Si or Ge atoms; and
k is 2; and ZR″Z′ has the C₁ symmetry.
